(19) United States
(12) Patent Application Publication
(10) Pub. No.: US 2026/0095846 A1
(43) Pub. Date: Apr. 2, 2026

(54) METHODS AND APPARATUS FOR READER DISCOVERY, SELECTION AND RESELECTION IN AMBIENT INTERNET OF THINGS (AIOT) SYSTEMS

(71) Applicant: InterDigital Patent Holdings, Inc., Wilmington, DE (US)

(72) Inventors: Martino FREDA, Laval (CA); Erdem BALA, East Meadow, NY (US); Paul MARINIER, Brossard (CA); Brian MARTIN, Farnham (GB); Jongwoo HONG, New York, NY (US); Aata EL HAMSS, Laval (CA); Remun KOIRALA, London (GB); Patrick TOOHER, Montreal (CA)

(73) Assignee: InterDigital Patent Holdings, Inc., Wilmington, DE (US)

(21) Appl. No.: 18/902,401

(22) Filed: Sep. 30, 2024

(51) Int. Cl. H04W 48/16; H04L 67/12; H04W 48/20; H04W 76/14; H04W 76/27; H04W 88/04

(52) U.S. Cl. CPC H04W 48/16; H04L 67/12; H04W 48/20; H04W 76/14; H04W 76/27; H04W 88/04

(57) ABSTRACT

A WTRU operating in RRC connected mode in an AIOT cell, may receive a command from the cell triggering a transition to an inactive mode of operation, wherein the command may comprise a first RSRP bias to be used during evaluation of non-AIOT cells and a second RSRP bias to be used during evaluation of AIOT cells. The WTRU may measure RSRP values from one or more cells, and, based on determining that a measured cell is a non-AIOT cell or an AIOT cell, apply the first RSRP bias or the second RSRP bias. The WTRU may select, based on the biased cell measurement results, one cell from the one or more cells measured. The WTRU may send, to an application layer, based on selecting a cell which is a non-AIOT cell, an indication of the lack of support of AIOT operations in the selected cell.

### BACKGROUND

In recent years, Internet of Things (IoT) has attracted much attention in the wireless communication world. More ‘things’ are expected to be interconnected for improving productivity efficiency and increasing comforts of life. Further reduction of size, complexity, and power consumption of IoT devices may enable the deployment of tens or even hundreds of billions of IoT devices for various applications and provide added value across the entire value chain. Manual replacement of batteries in IoT devices may lead to high maintenance cost, environmental issues, and even safety hazards for some use cases (e.g., wireless sensor in electric power and petroleum industry).

Considering the limited size and complexity required by practical applications for battery-less devices with no energy storage capability or devices with limited energy storage that do not need to be replaced or recharged manually, the output power of energy harvester is typically from 1 μW to a few hundreds of μW. Existing cellular devices may present peak power consumption of orders higher than 10 mW, adding a challenge when utilizing cellular devices for IoT applications that may require extremely low power consumption.

### SUMMARY

In an AIOT (AIOT) system, an AIOT device, such as a tag, communicates with a reader. The reader may be a UE. The tag may optionally communicate with an intermediate node, which may be a UE. The intermediate node may communicate with the base station, processing and/or relaying information associated with one or more AIOT devices. The reader or the intermediate node may have the capability of communicating directly with the AIOT device, over the AIOT interface, e.g., using RFID. The intermediate node may process and then relay the information between the base station and the AIOT device. The communication between the nodes may be bidirectional, allowing for data and/or signaling in both directions.

Radio Frequency Identification (RFID) systems are Internet of Things (IoT) systems comprising two types of AIOT devices, referred to as “tags” and “readers” or “interrogators”. RFID devices have at least one antenna that is used by the AIOT device to communicate with each other using signals. Different applications may take advantage of an RFID system such as inventory control, containers tracking, patient monitoring, pet finding, and children tracking, to name a few.

A UE may be configured to perform the functions of a reader or an intermediate UE. The UE may send an AIOT paging message an AIOT device to request information, such as during an inventory procedure. To respond to the request, the AIOT device may perform an access procedure. To enable AIOT devices to respond to requests and/or initiate communication with the UE, the access procedure may be defined.

As an example, in an inventory control system, an interrogator device (e.g., UE), may trigger multiple tag devices using a sequence of messages, to which the tag devices may respond to. In other words, the inventory procedure may comprise a single round of attempts of having each tag device respond or attempt to respond with its access ID or perform a random access procedure.

For a given set or group of AIOT devices, there may be one or more UEs than are feasible candidates to operate as readers to the devices. The process of deciding which reader will be assigned to a group of AIOT devices is referred to as reader selection. The reader selection may be device-based, in which case devices may determine the best reader UE, or network-based, in which case the network, or more specifically, the base station (e.g., gNB) performs the reader selection for each device or device group.

Once a reader is assigned to a group of AIOT devices, mobility of the reader UE may impact the selection decision. Accordingly, reader UEs may be configured with specific AIOT parameters and behaviors that are to be followed, e.g., when the UE is in idle or inactive mode. For example, specific cell selection and reselection parameters may be configured in UEs that are operating as readers. Different timer may also be assigned to such UEs. This allows the network to tailor the behavior of the UEs as they potentially move within the network.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a diagram illustrating an example communications system in which one or more disclosed embodiments may be implemented;

FIG. 1B is a system diagram illustrating an example WTRU;

FIG. 1C is a system diagram illustrating the RAN and the CN according to an embodiment;

FIG. 1D is a system diagram illustrating the RAN and the CN according to an embodiment;

FIG. 2 illustrates an example of a call flow of an inventory procedure using RFID devices;

FIG. 3 illustrates an example of call flows of two types of random access procedures that may be used in 5G New Radio (NR) systems;

FIG. 4 depicts the architecture of an example of a topology of an AIOT system—Topology 1;

FIG. 5 depicts the architecture of another example of a topology of an AIOT system—Topology 2;

FIG. 6 depicts the architecture of another example of a topology of an AIOT system—Topology 3;

FIG. 7 depicts the architecture of another example of a topology of an AIOT system—Topology 4;

FIG. 8 illustrates a baseline AIOT random access procedure;

FIG. 9 illustrates an example of a call flow for reader discovery procedure;

FIG. 10 illustrates an example of a call flow of reader UE1 being triggered to perform an inventory of all AIOT devices under its coverage;

FIG. 11 illustrates an example of a call flow of reader UE2 being triggered to perform an inventory of all AIOT devices under its coverage;

FIG. 12 illustrates an example of a call flow of the network-based reader UE selection; and

FIG. 13 illustrates an example of a call flow for reader UE reselection.

### DETAILED DESCRIPTION

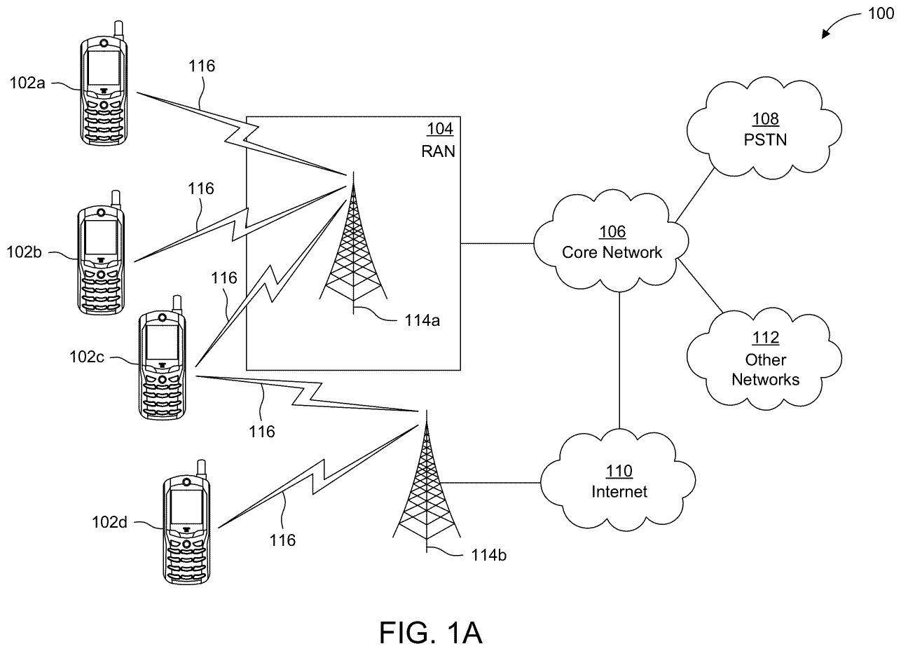

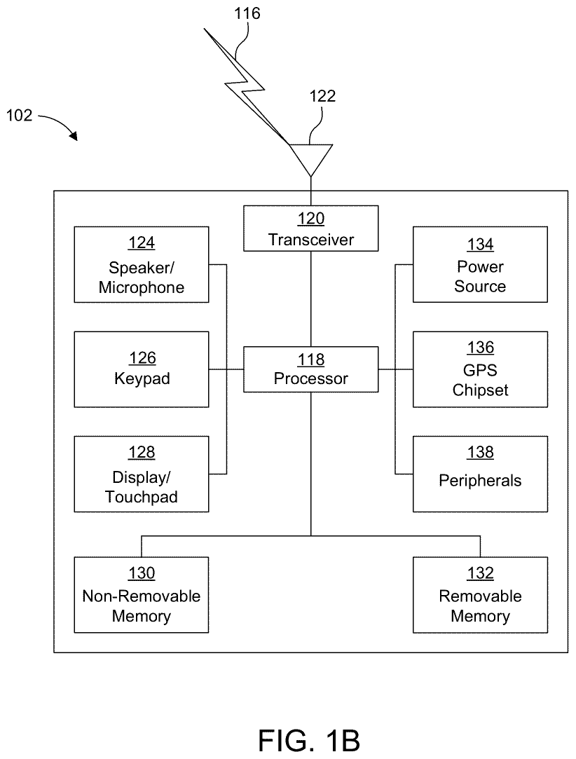

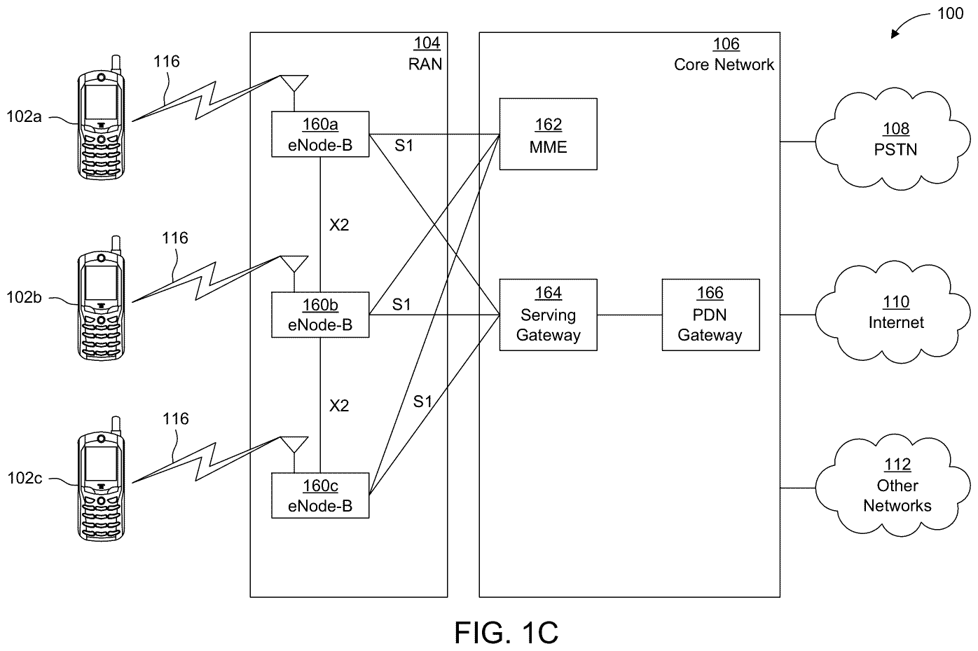

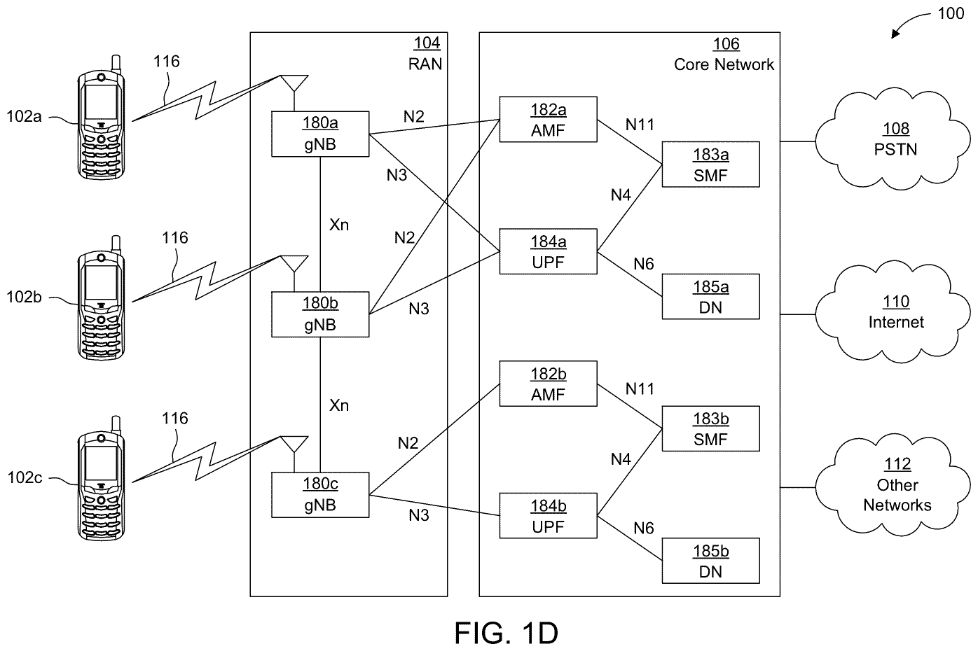

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other devices described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In recent years, Internet of Things (IoT) has attracted much attention in the wireless communication world. More ‘things’ are expected to be interconnected for improving productivity efficiency and increasing comforts of life. Further reduction of size, complexity, and power consumption of IoT devices may enable the deployment of tens or even hundreds of billions of IoT devices for various applications and provide added value across the entire value chain. Manual replacement of batteries in IoT devices may lead to high maintenance cost, environmental issues, and even safety hazards for some use cases (e.g., wireless sensor in electric power and petroleum industry).

In an AIOT (AIOT) system, an AIOT device, such as a tag, communicates with a reader or interrogator. The reader may be a UE. The tag may optionally communicate with an intermediate node, which may be a UE. The intermediate node may communicate with the base station, processing and/or relaying information associated with one or more AIOT devices. The reader or the intermediate node may have the capability of communicating directly with the AIOT device, over the AIOT interface, e.g., using RFID. The intermediate node may process and then relay the information between the base station and the AIOT device. The communication between the nodes may be bidirectional, allowing for data and/or signaling in both directions.

A UE may be configured to perform the functions of a reader or an intermediate node. The UE may page an AIOT device to request information, such as during an inventory procedure. To respond to the request, the AIOT device may perform an access procedure. To enable AIOT devices to respond to requests and/or initiate communication with the UE, the access procedure may be defined.

Radio Frequency Identification (RFID) systems are Internet of Things (IoT) systems comprising two types of devices, referred to as “tags” and “readers” or “interrogators”. RFID devices have at least one antenna that is used by the device to communicate with each other using signals. Different applications may take advantage of an RFID system such as inventory control, containers tracking, patient monitoring, pet finding, and children tracking, to name a few.

As an example, in an inventory control system, an interrogator device, may trigger multiple tag devices using a sequence of messages, to which the tag devices may respond to. In other words, the inventory procedure may comprise a single round of attempts of having each tag device respond or attempt to respond with its access ID or perform a random access procedure.

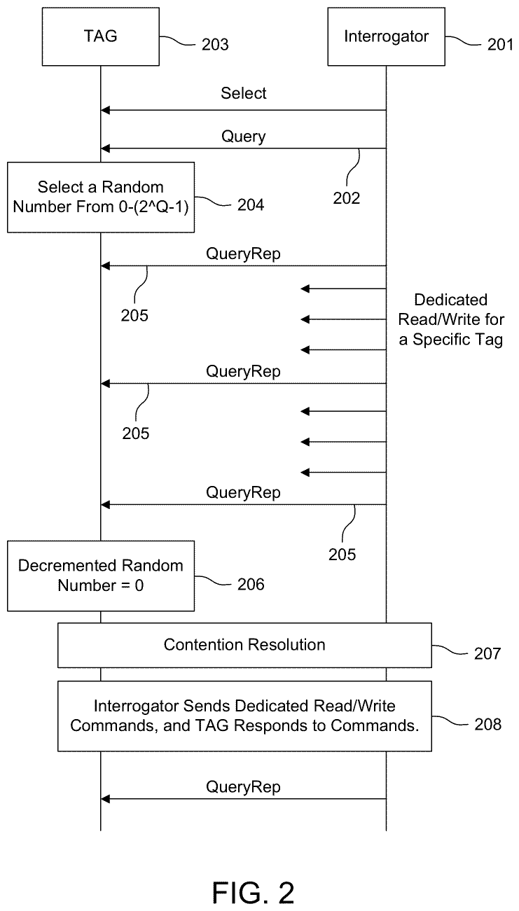

FIG. 2 illustrates an example of a call flow of an inventory procedure using RFID devices.

In the inventory procedure, an interrogator or reader 201 may send a Query message 202 to energize all or a subset of tags 203. Following the Query message 202, the tag 203 may select a random number from 0−2\hat{ }Q−1 204 and load its memory with that number. At each transmission of a QueryRep 205, the tag 203 decrements its counter until the counter reaches 0 206. When the counter reaches 0 206, the tag 203 may initiate a contention resolution procedure 207, which may include transmitting its device ID in the uplink, and waiting for confirmation of the device ID in the downlink (to address possible collision between multiple devices selecting the same random number). The interrogator (or reader) 201 may send multiple read/write commands 208 to a tag 203 that has passed the contention resolution, to which the tag may respond 208.

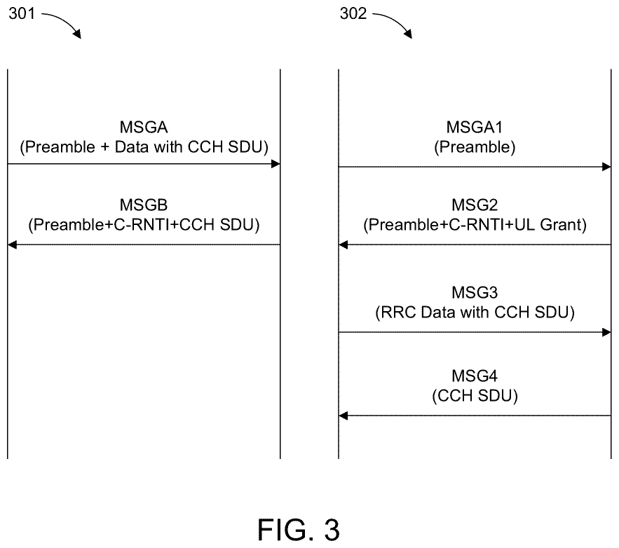

FIG. 3 illustrates an example of call flows of two types of random access procedures that may be used in 5G New Radio (NR) systems.

Random Access in 5G New Radio (NR) supports 2 types of random access procedures: 2-step 301 and 4-step 302 random access. A WTRU may decide between using 2-step 301 or 4-step 302 random access based on a number of factors.

A WTRU may decide between using 2-step 301 or 4-step 302 random access based on an reference signal received power (RSRP) threshold: If the cell level RSRP is above a threshold, the WTRU may use 2-step random access. The idea is that at cell center, 2-step random access may be sent because timing advance (TA) is minimal.

A WTRU may decide between using 2-step 301 or 4-step 302 random access based on history of previous attempts: If a number of 2-step procedures do not succeed, the WTRU may switch to a 4-step procedure. Specifically, the WTRU may be in cell center but the channel quality may not be sufficiently high to transmit data successfully.

A WTRU may decide between using 2-step 301 or 4-step 302 random access based on MSBB contents: If MSGB contains a fallback indication, and if the network is able to successfully decode the preamble, but not the data, then the procedure may continue as a 4-step random access procedure to recover the data after the TA is applied.

For AIOT, when a response is expected from multiple devices that are intended to be identified, an AIOT contention-based random access (CBRA) procedure may be initiated by the UE/reader. Additionally, for the CBRA procedure, slotted-ALOHA based access may be used, including either a 4-step or a 2-step procedure.

For the 4-step procedure, the following messages may be involved:
AIOT MSG1: the device sends an ID to the reader. The ID is a random ID generated by device.
AIOT MSG2: the reader echoes the random ID received in MSG1.
AIOT MSG3: the device sends an AIOT device ID (i.e., assigns a device ID to the AIOT device) and/or any other upper layer data to the reader (depending on upper layer request).
MSG4: This message may be transmitted by the reader for subsequently carrying data such as a command. Contention may already been resolved by MSG2.

For 2-step procedure, the following messages may be involved:
AIOT MSG1: The device sends a AIOT device ID and/or any other upper layer data (depending on upper layer request). The AIOT device ID is an ID that was previously assigned by the reader.
AIOT MSG2: The reader may echo some information from MSG1 (e.g., the device ID).

Different network topologies may be defined for an AIOT system.

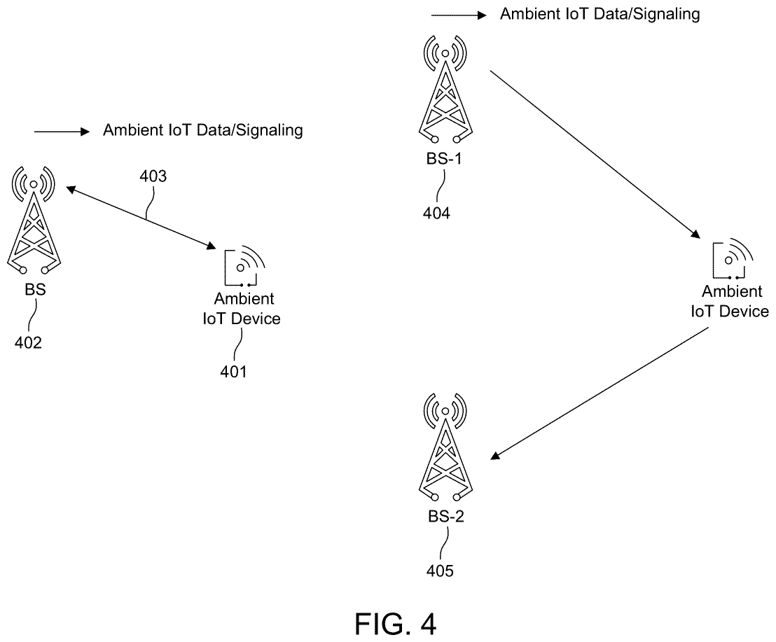

FIG. 4 depicts the architecture of an example of a topology of an AIOT system—Topology 1.

In topology 1, the AIOT device 401 may communicate with a base station (e.g., gNB, eNB) 402. The communication between the base station and the AIOT device may include data and/or signaling over the AIOT interface 403. In one example, the communication may be bidirectional, with one base station supporting the bidirectional communication. In another example, the communication may involve two base stations 404, 405, one base station 404 may be transmitting to a given AIOT device and another base station 405 may be receiving 405 from the same AIOT device.

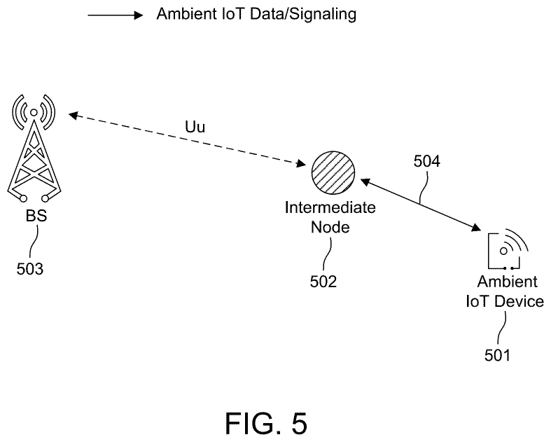

FIG. 5 depicts the architecture of another example of a topology of an AIOT system—Topology 2.

In topology 2, the AIOT device 501 may communicate with an intermediate node 502, and the intermediate node 502 may communicate with the base station 503. The intermediate node 502 may be, for example, a relay, an IAB node, a UE, an WTRU, or a repeater. The intermediate node may be referred to as intermediate WTRU. The intermediate WTRU 502 may have the capability of communicating with the base station (e.g., over the Uu interface) and of communicating directly with the AIOT device 501, over the AIOT interface 504 (e.g., using RFID). The intermediate WTRU 502 may process and then relay the information between the base station 503 and the AIOT device 501. The communication between the nodes may be bidirectional, allowing for data and/or signaling in both directions.

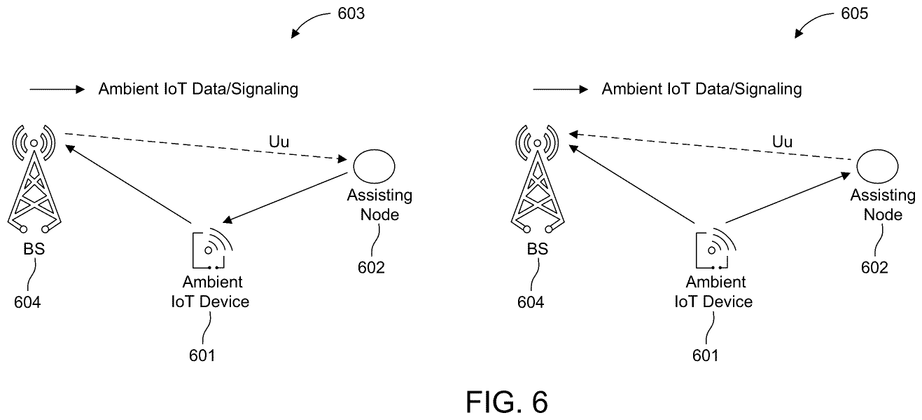

FIG. 6 depicts the architecture of another example of a topology of an AIOT system—Topology 3.

In topology 3, the AIOT device 601 may communicate using an assisting node 602. The assisting node 602 may be for example, a WTRU, a relay, an IAB, an UE, a repeater. The assisting node may be capable of AIOT communication. In one example, the assistance may be a downlink assistance 603. In the downlink assistance model, the AIOT 601 device may transmit data and/or signaling to the base station 604, and receive data and/or signaling from the assisting node 602. In another example, the assistance may be an uplink assistance 605. In the uplink assistance model, the AIOT device 601 may receive data and/or signaling from a base station 604 and transmit data and/or signaling to the base station and to the assisting node 602.

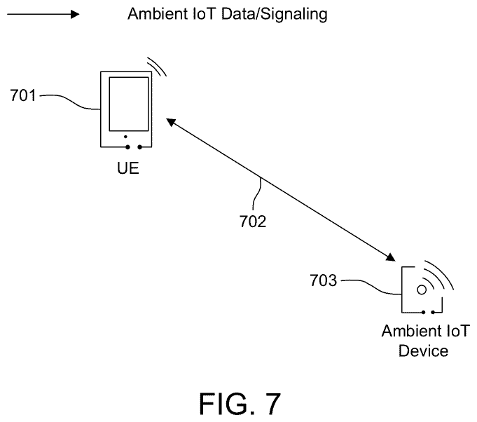

FIG. 7 depicts the architecture of another example of a topology of an AIOT system—Topology 4.

In topology 4, the AIOT device 701 communicates bidirectionally 702 with a UE 703. The communication between UE and the AIOT device includes AIOT data and/or signaling.

### Terminology

A “UE” or a “reader” may refer to the reader UE or interrogator or an “intermediate UE” from the AIOT topology 2 and may be used interchangeably with “reader” or “TRP” or “gNB” or any other entity (e.g., RAN entity) that can transmit and or receive the signals and messages (e.g., data signals, control messages, etc.) with the device or the AIOT device.

A “TRP” may be used interchangeably with “gNB”.

A “network” may refer to gNB/AMF/UPF/LMF, e.g., radio access network (RAN) or core network (CN).

The terms “pre-configuration” and “configuration” may be used interchangeably. The terms “configuration” or “pre-configuration” may refer to any configuration received by a message (e.g., an RRC message, a MAC CE, a PHY layer signal, a data PDU, a control PDU associated with any existing or new protocol layer) received from either a network node, or from another device or UE or WTRU. The term pre-configuration may refer to the process of pre-provisioning information is a device or UE or WTRU.

Random access procedure and/or contention based random access procedure and/or contention free random-access procedure and/or inventory procedure and/or query procedure and/or any other procedures for involving a reader (e.g., TPR, UE) acquiring and/or reading and/or determining the IDs (e.g., random IDs, temporary IDs, permanent IDs, etc.) from the devices (e.g., of one or more AIOT devices) may be interchangeably used.

The term “occasion” refers to the opportunity for device transmission that may be delimited by the transmission of a query rep message (or similar). Specifically, a device may perform transmission in an occasion by performing a AIOT transmission in a defined time following the query rep associated with that transmission. Alternatively, an occasion may comprise both a time aspect and a frequency aspect. Specifically, a device may determine an occasion as a transmission following a specific query rep, and by transmitting on one of a number of frequencies (e.g., FDM). Wherever solutions indicate selection of an occasion, they can apply equivalently to selection of only a time component and/or selection of a frequency component.

A “collision occasion” may refer to an time and/or frequency occasions where the UE may receive the signals and/or messages (e.g., random IDs, device IDs) from the AIOT devices but may not be able to decode the IDs.

An “idle occasion” may refer to time and/or frequency occasions where the UE does not receive any signals or messages from the devices.

Any reference to “time” may indicate an absolute time measurement (e.g., seconds, slots, frames) or it may indicate a number of executions of a procedure, possibly triggered by a reader (e.g., number of inventory procedures, number of accesses or RACH procedures). Alternatively, it may indicate a number of messages, possibly of a specific type, or containing specific information, received or transmitted.

A device herein may be configured by the reader, whereby the reader may be a network node or a UE (e.g., intermediate UE in topology 2). In the case of a UE, the UE may derive the device configuration itself, or receive the device configuration from the network, in which case, the device configuration is being relayed from the network to the device by the UE.

On the other hand, a UE configuration (in the case of a UE in topology 2) may be received from a network node (e.g., the gNB).

An “AIOT (AIOT) device” or a “device” may refer to a device (e.g., IoT device) that may be able to transmit and/or backscatter and/or receive data/IDs and/or control signals to and/or from RAN entities (e.g., gNB, UE, network etc.).

The term “resource” may refer to at least any of the following: a time and frequency resource in the traditional sense, a frequency resource which may be available at different times, a time resource, possibly limited to one or more frequencies or frequency ranges, which starts from the transmission of a reader message and which lasts either a maximum period of time, or until the next transmission by the reader, possibly of a specific message

“Inventory” refers to the overall procedure of a reader triggering access by multiple devices using a sequence of messages (e.g., similar to query, followed by query rep in RFID). Specifically, the inventory procedure refers to a single round of attempts to have each device respond or attempt to respond with its access ID, or perform a RACH procedure. Specifically, the inventory procedure refers to a set of access occasions which may have 0 or at least 1 device respond within the access occasion. Inventory procedure may occur similar to legacy RFID procedure. Although referred to herein as inventory procedure, it may be termed differently in device requirements or specifications (e.g., query procedure, paging procedure, etc.).

Referring to topology 2, the network may rely on one or more intermediate UE readers to perform inventory and send commands to a group of AIOT devices. When the network (e.g., CN) initiates an AIOT procedure, it may send the command that triggers the procedure to one or multiple UEs that were selected as readers.

As intermediate UEs may move, it may become necessary to select a new intermediate UE for a given device or set of devices. From one aspect, when the CN performs an inventory procedure, it would be beneficial if the CN can send the triggering command directly to the UE which best suits a specific device, regardless of the movement of the UE. Additionally, reselection of a new reader to issue AIOT commands to specific devices may be necessary. For example, some cells may not support AIOT and a UE should not be used as a reader if the UE is in such cell. In this case, another nearby UE, belonging to another cell which supports AIOT, may be selected. The selection and reselection mechanism may be too complex for a device to perform on its own. AIOT devices have power limitations, and collecting measurements to select best UE reader, such as measuring RSRP, may not be feasible. Furthermore, the use of periodic signals, such as the UE sending discovery signals, to enable the UE selection may also be problematic due to the power required by the UE to keep sending signals.

Accordingly, it is important to have a mechanism to perform intermediate reader UE selection, in topology 2 ambient IOT, with minimal power consumption and minimal complexity at the AIOT device. This may enable the network to send AIOT commands to the most appropriate reader(s) and limit multiple readers initiating redundant operations.

During reader selection, an intermediate (reader) UE may receiving, from the network, a request to perform an inventory procedure, including an associated set of AIOT resources. The UE may perform the inventory procedure towards the devices, over the AIOT interface, by first transmitting an AIOT paging message. The paging message may trigger a random access from all AIOT devices indicated in the paging message. The UE may measure the device RSRP or determine the proximity level of each responding device and store upper layer device ID (MSG3) from each device that successfully completes random access.

The UE may then transmit, to the base station, e.g., in an RRC message, a list of RSRP/proximity level (e.g., in an RRC message), possibly in the same order as the list of device IDs. The UE may receive a release message, transitioning the UE to RRC inactive state. The release message may include an indication for the UE to act as a reader and it may include an AIOT-specific reader RRC inactive configuration (e.g., RSRP bias for non-AIOT cells and a time period during which to apply the RSRP bias).

During RRC idle or inactive, the UE will perform cell selection evaluation. The UE may determine whether a cell supports AIOT, perform cell measurements, and apply the configured bias to cell measurements based on: the support of AIOT in the cell and the configured time period during which to apply the RSRP bias.

The UE may trigger an RRC resume procedure and, if the UE is configured to be an active reader, and if the UE selects a cell which does not support AIOT operation while the configured time period has not expired, the UE may inform the upper layers of such.

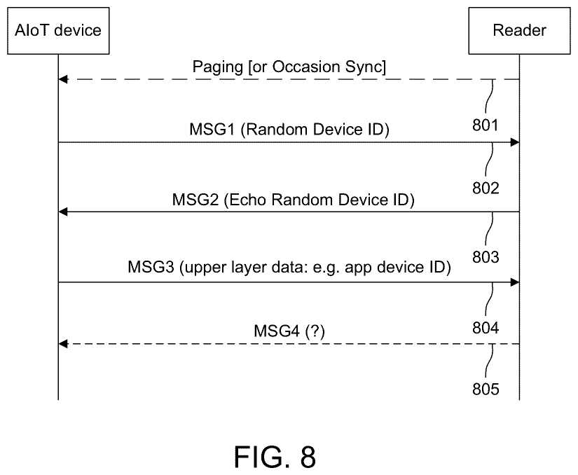

FIG. 8 illustrates a baseline AIOT random access procedure.

The reader sends a paging message 801 and a set of occasion synchronization messages which respectively include the device IDs of the devices that are to respond and configures/delimits the random access occasions for transmissions by the AIOT devices. An AIOT device selects an occasion (using at least slotted ALOHA as the baseline), and transmits a random device ID in MSG1 802. The reader, upon successful reception of MSG1, transmits MSG2 by echoing the received random device ID in MSG2 803. If the device receives the echoed random device ID in MSG2, it transmits MSG3 804, which may contain upper layer data (e.g., an application layer device ID). MSG4 may be transmitted by the reader 805 (e.g., for subsequent command transmission), but the understanding is that contention is already resolved at MSG2 transmission.

### Reader UE receives Operation-Specific Uu Paging

### Paging to Trigger a Connection Establishment (Based on Support of AIOT, or Based on Some Conditions, Where the Conditions Themselves May be Included in the Paging Message)

In one example, a UE may receive a paging message triggering a connection establishment or connection resume. This may be based on the fact the UE supports AIOT reader operation and/or other conditions related to an AIOT operation. Specifically, the paging message may contain an indication or information about the UE(s) which should trigger paging, possibly without needing the specific UE IDs of the UEs being paged.

In another example, a paging message may trigger a connection establishment for any UE supporting reader functionality. In this case, if a UE which supports reader functionality receives such paging message, the UE may initiate connection establishment/resume.

In another example, a paging message may trigger a connection establishment for any UE which supports reader functionality for a specific type of device (device type 1, device type 2, etc.). In this case, if a UE which supports reader functionality for that type of device receives such paging message, the UE may initiate connection establishment/resume.

In another example, a paging message may trigger a connection establishment for any UE which supports inventory of at least a specific number of devices. The number of devices supported for inventory may be defines as part of the UE's capabilities. For example, if a UE receives a paging message, possibly containing a threshold number of devices to be inventoried, the UE may trigger connection establishment/resume if it can support inventory of at least the threshold number of devices.

In another example, a paging message may trigger connection establishment for any UE which is currently performing an AIOT reader operation, such as an inventory operation. For example, if a UE is performing an AIOT reader operation and it receives such paging message, the UE may initiate connection establishment/resume.

In another example, a paging message may trigger connection establishment for any UE which has stored AIOT results. For example, if a UE has completed an inventory or a command procedure and has stored AIOT results (e.g., command response, inventory results) and it receives such paging message, the UE may initiate connection establishment/resume.

In another example, a paging message may trigger connection establishment for any UE which has failed an AIOT operation (e.g., command procedure which did not succeed). For example, a reader UE may initiate an AIOT procedure and determine that an operation failed. This may be based on the reception of a negative response from the AIOT device, or a lack of a positive response from the AIOT device. If the UE receives such paging message following the failed operation, it may trigger connection establishment/resume. Such a UE may further report information about the failure during or following connection establishment. For instance, the UE may provide a failure cause value.

In another example, a paging message may trigger connection establishment of readers for which an AIOT operation performed by the reader generated results which meet specific criteria. The paging message itself may further contain such criteria. For example, the paging message may contain a threshold number of devices which have responded to an inventory procedure. If a reader UE receives such paging message after performing an inventory procedure, it may trigger connection establishment/resume if the number of devices which successfully responded to the inventory procedure exceeds the threshold value in the paging message. As another example, the paging message may contain the identity of a specific device or a group of devices. If a reader UE has successfully inventoried a specific device or group of devices and it receives such a paging message with the relevant identity, the reader UE may initiate connection establishment/resume. As another example, a paging message may contain a threshold size of data read from a read command. If a UE receives such a paging message, and if the UE has performed a read command and received an amount of data which is larger than the threshold amount, the UE may initiate connection establishment/resume upon reception of the paging. In this case, a paging message may trigger connection establishment of readers based on results of previous AIOT operations initiated by the reader.

In another example, the reader may trigger connection establishment/resume if the number of correctly inventoried devices in the last (x) inventory procedure(s) is larger than a threshold In another example, the reader UE may trigger connection establishment/resume if all of the devices (or at least a configured ratio of the devices) that were included in the last ‘x’ AIOT paging/trigger message(s) successfully responded to the reader UE.

In another example, the reader UE may trigger connection establishment/resume if the last inventory procedure was completed in less than ‘x’ seconds, where the value of ‘x’ may be provided in the paging message

In another example, the reader may trigger connection establishment/resume if the last inventory procedure resulted in less than ‘x’ random access failures detected by the reader, where ‘x’ may be included in the paging message

In another example, the reader may trigger connection establishment/resume if the last inventory procedure resulted in at least ‘x’ new devices having responded compared to the previous inventory. ‘x’ could be set to 1.

In another example, a paging message may trigger connection establishment of readers for which measurements of the device transmission power meets a specific criterion. For example, the paging message may contain a threshold ‘x’ on received signal RSRP/RSSI. If a reader UE receives such paging message and has measured at least a given number of devices, ‘y’, which fall within the threshold ‘x’, (e.g., during the last inventory, y devices measured RSRP >x, y=1, 2, 3, . . . ), the reader may trigger a connection establishment/resume procedure. In another example, a reader UE may respond to a paging if the measured RSRP/RSSI of at least ‘y’ devices has changed from the previous inventory by at least a threshold amount, ‘z’. The values of ‘x’, ‘y’ and ‘z’ may be configured or included in the paging message.

In another example, a paging message may trigger connection establishment of UE readers which are considered suitable based on characteristics of the reader's mobility.

In another example, the reader may trigger connection establishment/resume if its measured mobility level is above or below a threshold.

In another example, the reader may trigger connection establishment/resume if it has not performed a cell reselection in the last ‘x’ seconds.

In another example, the reader may trigger connection establishment/resume if the number of cell reselections performed in the last ‘x’ seconds is less than ‘y,’ where ‘x’ and ‘y’ may be configured or included in the paging message.

In another example, the reader may trigger connection establishment/resume if the Uu measurements of its serving cell has not changed by more than a threshold during a certain period of time.

In another example, the reader may trigger connection establishment/resume if its geolocation/position has not changed by more than ‘x’ meters in a specific period of time (e.g., since the time the UE was moved to RRC idle or inactive).

Reader UE receives re-attempt flag to use in an AIOT paging, from the network.

In one example, a reader may receive the value of an indication or flag to be used in the AIOT paging message to control the devices' inventory re-attempts, e.g., a re-attempt flag. A device may respond to all of the paging messages received from different readers if the paging message includes the re-attempt flag. Specifically, the presence of the re-attempt flag may trigger a device to respond to each of the paging messages coming from the same or different reader and having the same instance number. If the device does not receive the re-attempt flag, the device may only respond to an instance of an inventory once (e.g., the first time that instance of the inventory is received) or from one specific reader. Specifically, when the re-attempt flag is not included, subsequent AIOT paging (after the device successfully performs inventory) by the same or different readers may be ignored by a device if the subsequent paging messages are associated with the same service or instance identity.

If a reader receives the re-attempt flag, it may include such flag in the AIOT paging message that triggers an AIOT operation (e.g., inventory). The reader may also include a paging identity received from the network into the AIOT paging message in order to identify the instance of the operation received from the network. In one example, a reader may receive the re-attempt flag explicitly. In another example, the reader may determine the re-attempt flag based on one factor or a combination of factors.

For example, the device identities associated with the AIOT operation request received from the network may be used. For instance, if the reader receives consecutive AIOT operation requests with different device identities, the reader may set the re-attempt flag.

As another example, the number of requests from the network or specific network entity (e.g., on a given cell, RAN area, tracking area, PLMN, configured list of cells, application server, etc.) may be used. For instance, if the reader receives a request for the first time from a specific network entity, the reader may set the re-attempt flag.

As another example, the time since the last network request may be used. For instance, if the time since the last network request exceeds a threshold, the reader may set the re-attempt flag.

As another example, the contents of the request from the network may be used. For instance, the reader may determine whether to set the re-attempt flag based on specific content, configuration, or information provided in the request (e.g., configuration for initial discovery of readers).

A device may perform reader selection when it receives one or more AIOT paging messages with the re-attempt flag set. This may consist of deciding which reader the device will respond to for future AIOT operations (which possibly may not have the re-attempt flag set). This may consist of transmitting different information or information elements (e.g., during the random access procedure, or along with any upper layer data sent to the reader) to the different readers. Such behaviors are described further in the next section.

### Network-Based Reader (Re)Selection Procedures

### Reader UE has Modified Idle/Inactive Mode Behavior

In one example, a reader UE may be configured with certain behavior for RRC idle and/or inactive mode. Such behavior may be any one or a combination of the behaviors described in the following paragraphs. A UE may be configured to perform the behavior based on one or more factors or a combination of factors.

A UE may be configured with the idle/inactive mode behavior based on explicit network configuration.

In one example, a UE may be configured with a flag (e.g., in an RRC configuration, or in a SIB) to perform reader specific idle/inactive mode behavior. For example, a UE may be provided with a flag in a release message which sends the UE to idle or inactive mode, and the UE may perform the behavior after receiving the release message. In one example, a UE may receive an idle/inactive mode configuration, which may dictate the behavior, and may perform the behavior if it receives such configuration

In another example, a UE may determine whether to perform reader specific idle/inactive mode behavior based on the network response to a resume procedure or RAN area update procedure. For example, this may comprise the information in an RRC message the UE receives in response to a resume request. For example, reader specific idle/inactive mode behavior may be initiated by a UE if it receives a release following a resume request message transmission, possibly where the resume request message transmission was initiated by an AIOT operation, a reader selection procedure, or a new resume trigger resulting from AIOT operation as a reader.

A UE may be configured with the idle/inactive mode behavior based on a time period.

In one example, a UE may perform a specific behavior for a certain duration in time. For instance, the duration of time may start at the release to idle/inactive state. In another example, the duration of time may start at the start of an AIOT operation triggered by the UE. In another example, the duration of time may start at the receipt (e.g., from higher layers) of an AIOT request. In another example, the duration of time may start at the transmission of a message (e.g., paging, command) by the UE over the AIOT interface to one or more devices. In another example, the duration of time may start at a specific slot or subframe configured by the network to serve as reference for AIOT operation. In another example, the duration of time may start at the reception of a message from a device (e.g., MSG1, MSG3 in random access, command response). In another example, the duration of time may start at completion of an AIOT operation (e.g., command, inventory). In another example, the duration of time may start following the reporting of AIOT results to the network.

In one example, a UE may receive such a time period (e.g., a timer) in the idle/inactive mode configuration which enables such UE behavior.

A UE may be configured with the idle/inactive mode behavior based on a location of the UE.

In one example, a UE may be configured with the idle/inactive mode behavior when camped on a cell or specific group of cells (e.g., configured by the network). In another example, a UE may be configured with the idle/inactive mode behavior when camped on a cell which supports/does not support AIOT operations. In another example, a UE may be configured with the idle/inactive mode behavior when the UE is located in a specific (range of) geographical coordinates (e.g., GPS).

A UE may be configured with the idle/inactive mode behavior based on a change of location of the UE. Some examples of location where discussed in the previous paragraph. In one example, a UE may initiate/stop the modified idle/inactive mode behavior when the UE's speed is above/below a specific threshold. In another example, a UE may initiate/stop the modified idle/inactive mode behavior when the UE has moved from a cell that supports AIOT operation to a cell which does not support it, or vice versa. In another example, a UE may initiate/stop the modified idle/inactive mode behavior if it performs more/less than a configured number of cell reselections within a configured period of time.

A UE may be configured with the idle/inactive mode behavior based on a bearer/QoS configuration at the reader UE. For example, a UE may perform modified idle/inactive mode behavior if it is configured with at least one AIOT-specific bearer or QoS flow, if a QoS parameter (e.g., priority, bit rate, latency) associated with such bearer or QoS flow meets some configured conditions (e.g., priority higher than a threshold). In another example, a UE may be configured, as part of the bearer configuration, as to whether to perform modified idle/inactive mode behavior. For example, a UE may perform (not perform) such modified behavior if it has at least one bearer configured with a specific property

A UE may be configured with the idle/inactive mode behavior based on the type of operation at the reader. For example, a UE may perform modified idle/inactive mode behavior for a subset of AIOT operations. For example, it may be performed for ‘inventory+command’ procedure, but not for inventory only or command only. In another example, it may be performed for command only operation.

The idle/inactive reader behavior may comprise modified cell reselection rules.

For example, a reader UE may be configured to disable cell reselection evaluation/triggering. The reader UE may disable cell reselection/triggering for a configured period of time. The reader UE may disable cell reselection/triggering for some time corresponding to an operation on the AIOT interface, for example, for the time period between a reader UE's transmission and a corresponding/related device transmission, for the time period between a device transmission (e.g., reception of MSG1 by the UE) and the reader UE's response (e.g., transmission of MSG2 by the UE), for the duration of the inventory procedure, for the time period in which a UE is communicating in unicast with a device (i.e., the device has succeeded random access, and the reader has data to send to the device)

For example, a reader UE may be configured to delay a triggered cell reselection, possibly by a configured time, until an event occurs as discussed in the previous example.

For example, a reader UE may be configured with modified measurements of the current cell or potential other cells during cell reselection evaluation. In one example, a UE may be configured with an offset, bias, or similar to apply to a cell measurement during reselection evaluation. For example, a UE may be configured to apply a bias to a cell (e.g. to prioritize remaining on the serving cell) while it has an ongoing reader operation on the AIOT interface. For example, the UE may be configured to apply a bias to certain cells while it is configured as a reader and/or while it has an AIOT operation running. For example, a UE may be configured with a set of cells associated with an allowable or preferred area for AIOT. For example, a UE may be configured with a set of cells having a common set of AIOT resources. If/when the UE is configured as a reader and/or is performing an AIOT operation, the UE may apply a configured bias to those cells during reselection evaluation. For example, a UE configured as a reader may be configured to apply a measurement bias to any cell which does not support AIOT operation (e.g., based on indication of support in the SIB of the cell). For example, a UE may modify cell measurements meant for reselection evaluation during a configured time period after initiation/completion of an inventory operation. For example, a UE may modify cell measurements meant for reselection evaluation between the time that an inventory has been initiated/completed, and the trigger of a subsequent command procedure.

The idle/inactive reader behavior may be to prioritize certain suitable cell(s) over other cell(s) during the reselection decision. In one example, a reader may be configured to prioritize one cell over another during reselection based on the relationship of those cells to the AIOT operation. For example, when reselection is triggered and a UE determines multiple suitable cells (cells to which a UE can perform reselection to), the UE may prioritize/select the cell which supports AIOT operation versus the cell which does not support AIOT operation, or may prioritize/select the cell which have a common set of AIOT resources compared to the current serving cell.

In one example, a reader UE may trigger establishment/resume based on the cell to which reselection is triggered. For example, a UE may initiate establishment/resume procedure following cell reselection/resume to a cell having the relationships described above. For example, a UE may trigger establishment/resume when reselecting from a cell supporting AIOT to a cell not supporting AIOT, or vice versa. For example, a UE may trigger establishment/resume when reselecting to a cell which has a different AIOT resource configuration from the source cell. For example, a UE may trigger establishment/resume when reselecting to a cell which is outside of the common area for a (possibly ongoing) AIOT operation, or outside of a configured area or list of cells.

In another example, a reader UE may trigger establishment/resume based on Uu measurements. In one example, a UE may initiate establishment/resume procedure based on the Uu measurements of the serving cell. For example, a UE may trigger establishment/resume procedure when the serving cell measurements change by at least a configured threshold, possibly while performing an AIOT operation. For example, a UE may trigger establishment/resume procedure when the Uu measurements are above/below a threshold when an AIOT operation is initiated or terminated. For example, a UE may trigger establishment/resume procedure when the Uu measurements go above/below a threshold during an AIOT operation.

In another example, a reader UE may trigger establishment/resume based on the type of operation at the reader UE. For instance, a UE may initiate establishment/resume procedure, possibly after the completion of one AIOT procedure, based on the type/duration of the AIOT operation which was configured or initiated at the reader UE. For example, if a UE receives an inventory only operation from the network, it may not initiate a connection establishment upon completion of the inventory but rather wait for another trigger herein. On the other hand, if a UE receives an inventory+command procedure from the network, it may initiate an establishment/resume procedure upon the completion of the inventory procedure, or the ‘inventory+command’ procedure.

Whether or not a UE triggers a connection establishment/resume procedure, possibly following a cell reselection, may depend on the type/duration of the AIOT operation. For example, a UE may trigger a connection establishment/resume procedure if it has an ongoing AIOT operation being performed and it performs a cell reselection. For example, when an ‘inventory+command’ procedure is triggered, a UE may trigger connection establishment/resume if it performs cell reselection to a cell which is not in a configured list of cells provided by the source cell (or the cell initiating the inventory procedure). Specifically, a cell may configured a list of cells (similar to a tracking area or RAN area). If the UE receives an ‘inventory+command’ operation, it may trigger an establishment/resume as a result of a reselection to a cell outside of the configured list, if the reselection occurs while the operation is ongoing. On the other hand, if the operation is an inventory only, the reader may be allowed to perform cell reselection to a cell outside the configured area (e.g., the tracking area or RAN area) without initiating an establishment/resume, when the reselection is performed while the operation is ongoing. For example, a UE may initiate establishment/resume procedure following reselection if there is at least one pending command message to be received for a particular device which is still to be received by the reader during an ongoing ‘inventory+command’ procedure.

In another example, a reader UE may trigger establishment/resume based on measurements of one or more devices. For example, a UE may initiate establishment/resume procedure, possibly after a cell reselection, possibly after reselecting to a cell outside a configured area, based on the measurements of one or more devices which respond to an AIOT operation (e.g., inventory). For instance, a reader UE may be configured with a threshold difference in device transmission quality. If the received quality of any (or a threshold number of) device transmissions in different AIOT procedures changes by at least the configured threshold quality, the reader may initiate an establishment/resume procedure. For example, if the received quality of any (or a threshold number of) device transmissions in different AIOT procedures changes by at least a threshold after a reader performs a reselection (possibly to a different cell or list of cells), the reader may initiate an establishment/resume procedure.

In another example, a reader UE may trigger establishment/resume based on the time since/between separate AIOT procedures. Whether or not a UE initiates establishment/resume procedure, possibly following a cell reselection, possibly during an AIOT procedure, may depend on the time since the last AIOT procedure or the time between successive AIOT procedures. For example, if the time between the current AIOT procedure and the previous AIOT procedure is above a threshold, the reader may trigger a resume/establishment procedure upon cell reselection, possibly if the cell reselection occurs during an AIOT operation.

Without loss of generality, the above solutions may apply not only to initiating an establishment/resume, but also to determining the type of access (e.g., CN access or RAN access) following a reselection, or on providing information in the resume/access. For example, based on one or more conditions above, the reader may include a different cause value in the resume/access.

The reader UE may provide information to the network when establishment/resume is triggered. In one example, a reader UE may include information related to the establishment/resume trigger when moving to RRC connected. For instance, a reader UE may include the information in an RRC message transmitted following successful establishment/resume. For example, a reader UE may include the information in an IE included within the resume request message, RRC setup message, measurement report, etc. For example, a reader UE may indicate the information based on selection of specific random access resources selected when performing the connection establishment/resume.

Upon establishment/resume trigger, a reader UE may provide, to the network, an indication of the cause, where such indication may explicitly indicate any of the above triggers for establishment/resume. For example, the UE may indicate that it has performed resource selection from a cell which supports AIOT to a cell which does not support AIOT. For example, the UE may indicate that it has performed resource selection during an AIOT procedure. Any of the triggers discussed above may be indicated as part of a resume/establishment cause. The UE may include such cause when the trigger is met.

Upon establishment/resume trigger, a reader UE may provide, to the network, information related to the condition for establishing the connection. For example, the UE may include any measurement or determination which is part of any of the conditions described herein for establishing a connection, such as establishing a connection due to reception of paging or reselection. For example, the UE may indicate the number (ratio of paged) of devices which responded, possibly in the last AIOT operation triggered by the UE. For example, the UE may indicate a measure of its mobility, possibly during the AIOT operation or while it was configured as an active reader, where measure of mobility may be any of the aspects described herein. For example, a reader UE may include the (average) number of failed device access attempts in the setup/resume request message.

Upon establishment/resume trigger, a reader UE may provide, to the network, information related to reselection to a cell which does not support AIOT. For example, if the UE reselects to a cell not supporting AIOT, the UE may further include measurements of the other cells possibly supporting AIOT to the reselected cell.

The reader UE may determine whether to initiate CN access or RAN access (e.g., TAI-like vs RAI-like procedures). In one example, a reader UE may determine the type of access to perform based on conditions related to AIOT operation described herein. For example, the type of access may consist of a CN access (e.g., similar to tracking area update) versus a RAN access (e.g., similar to a RAN area update). For example, the type of access may relate to the cause value that is included in the access (RNAI vs TAI). For example, the type of access may consist of whether the UE triggers a release of the context prior to the access. For example, a first type of access may consist of a resume from inactive state, while a second type of access may consist of releasing the context, moving to idle/inactive state and performing an initial access. For example, the type of access may consist of the RRC message (e.g., RRC resume request vs RRC setup request) that the reader UE uses to perform the access.

A reader UE may determine the access type based on support of AIOT by the source/target of a cell reselection. For example, a UE may trigger a first type of access (e.g., RRC setup) if it reselects to a cell which does not support AIOT procedure, and a second type of access (e.g., RRC resume) if it reselects to a cell which supports AIOT procedure.

A reader UE may determine the access type based on the configuration supported for AIOT by the source/target cell of a reselection operation. For example, a UE may perform a first type of access if it reselects to a cell with the same/similar AIOT resource configuration and a second type of access if it reselects to a cell with a different AIOT resource configuration.

A reader may determine the access type based whether it has pending results of an AIOT procedure. For example, a UE may perform a first type of access if it has pending AIOT results to report and may perform a second type of access if it does not have any pending AIOT results to report.

A reader may determine the access type based on whether the reader is in the middle of an ongoing AIOT procedure. For example, the UE may perform a first type of access if it is in the middle of an AIOT inventory procedure, and a second type of access if it is not.

A reader UE may provide a list of devices information to the base station (e.g., gNB). The list may be an ordered list. For instance, a reader may provide an ordered list of AS layer information for each of the devices that respond to an AIOT operation triggered by the reader. The list may be provided by the reader in an RRC message transmitted in uplink. The list may be provided while the reader is in RRC connected. Alternatively, the list may be provided together with an RRC message used to initiate a connection establishment/resume (e.g., in an RRC resume request message or in an RRC setup message).

A reader may provide a list independently of the inventory results. Specifically, in an architecture where the inventory is triggered by the core network, a reader may provide the inventory results in a NAS message, while providing the information list in an RRC message.

A reader may include an entry for each device that is successfully inventoried into the ordered list, using the same order in which the devices responded to the inventory. Alternatively, a reader may include an entry for each device that attempted the inventory, possibly with an indication in the list of whether the device successfully completed inventory or not. Alternatively, a reader may include only an entry for a device if there is a change in an information element for that device relative to the previous operation (e.g., a previous inventory). A reader may include an index with each entry, where each index corresponds to the successfully inventoried device whose inventory results are sent by the reader (e.g., in a NAS message).

A reader may include measurements (e.g., RSRP, RSSI) for the devices in the list. For example, a reader may include a measured RSRP of the device's transmission (e.g., transmission of MSG1, MSG3, transmission of command response). For example, a reader may include an average measured RSRP of the device transmissions during the AIOT operation (e.g., all device transmissions during an inventory procedure). For example, the reader may include a ratio of the received RSRP to the power of a carrier wave signal which may be transmitted by the reader.

In another example, a reader may include the measurements of a device if the measurements have changed by at least a threshold compared to the last time the measurements were included in a report from the reader. For example, a reader may include the measurements of a device if the device is being inventoried for the first time, possibly within the control of a cell or within a configured list of cells

For example, a reader may identify the information for the device in the list by including an index relative to the set of devices inventoried (and transmitted in an upper layer message such as a NAS message). For example, a reader may identify the information for the device in the list by including an index relative to the set of devices paged (in the AIOT paging message transmitted by the reader).

For example, a reader may include the cell ID(s) where the device was inventoried, specifically, the cell ID where reader was camped when it received the inventory response (e.g., MSG3) or command response from the device. For example, if the reader performs multiple inventory procedures, the reader may include the list of all cell IDs where the device was successfully inventoried.

For example, a reader may include the device identity of the device that was inventoried. For example, this may be a device ID transmitted by the device during the inventory (e.g., included in MSG3 of the random access, or in the command response). For example, this may correspond to the random identity sent by the device in MSG1. For example, this may consist of the index of the device within the list of paged devices in the AIOT paging message transmitted by the reader

For example, a reader may include a number of attempts associated with the device's response. For example, this may consist of the number of transmissions of a specific message (e.g., MSG1, MSG3) by the device until the device's transmission is successfully received by the reader. For example, the device may increment a counter for each attempted transmission by the device until the reader successfully receives the transmission. The reader may include the value of this counter received from the device in the transmission to the network. In another example, a reader may include a number of retransmissions of the paging message.

For example, a reader may include an index or identifier which identifies the specific resource, occasion, or paging round, in which the reader received the device's transmission. This may correspond to an occasion index, an access round index, a resource index, a frequency resource index, or an index used to cover a combination of any of these.

A reader may be configured to include the device list and/or a specific element in the device list. For example, a reader may be configured to include only a subset of the information described above. For example, a reader may be configured to include the information only for a subset of devices. For example, the reader may receive such configuration in SIB or dedicated signaling. For example, the reader may include such information if configured to do so by the network (e.g., in the RRC release message).

Alternatively, a reader may include the device list and/or a specific element in the device list, possibly at the resume/establishment on Uu, based on specific events which may occur at the reader. For example, the UE may include one or more elements or the list of information if the UE performs cell reselection, handover, or re-establishment, possibly during an AIOT operation.

For example, the UE may include one or more elements or the list of information if the cell level RSRP changes by at least a threshold. For example, the UE may include one or more elements or the list of information if the Uu RSRP is above/below a threshold. For example, the UE may include one or more elements or the list of information if a device's measured signal quality is above/below a threshold.

For example, the UE may include one or more elements or the list of information if the AIOT operation is of a certain type (e.g., inventory only, ‘inventory+command’). For example, the UE may include one or more elements or the list of information if the AIOT operation experienced one or more failures (e.g., at least one device failed MSG1 transmission, at least one device failed MSG3 transmission).

[Device Provides Information to Perform and/or Assist Reader (Re)Selection]

A device may perform access during inventory differently depending on the presence/absence of information in the paging message of the inventory. In one example, the information may a reader identity, a session identity, an indication of the mode of operation, or mode of inventory. These may signal a different type of inventory attempt request by the network. This may be similar to the re-attempt flag described in previous paragraphs. It may indicate whether the inventory procedure is being performed as part of a reader discovery procedure, a reader selection procedure, or an update inventory procedure.

In another example, the information may be an attempt number, which may indicate the number of additional inventory triggers which may be performed by the reader following the current one. In another example, the information may be an indication of whether a subsequent operation will be attempted by the same or different reader following the current one.

A device may perform access differently, depending based on information in the paging message. For example, a device may decide whether or not to provide a control element in a device transmission. Such control element may comprise an indication of a selected reader. Such control element may comprise a request for the network to reselect a reader for that device. Such control element may comprise a measured quality or a quality level, determined by the device, relative to the reader transmissions. Such a control element may comprise an indication of the device's currently available energy.

In another example, a device may decide whether to respond to an inventory (e.g., to respond to an AIOT paging message) or to delay the response until it receives a subsequent inventory (e.g., a subsequent AIOT paging message). In another example, a device may decide whether to respond to multiple inventories (multiple AIOT paging messages) associated with the same reader ID or session ID. In another example, a device may decide whether to perform a given subset of the steps associated with a random access, or all the steps. In another example, a device may decide whether or not to send upper layer data in MSG3. In another example, a device may decide whether or not to send a control element in MSG3.

In one example, a device may respond to all readers (e.g., send redundant responses) during a network triggered discovery procedure. Specifically, a device receiving inventory requests with the same session identity may determine whether to respond to a single request or multiple requests based on the presence of a flag (e.g., a re-attempt flag) in the inventory request. For example, if the paging message for the inventory contains a re-attempt flag, the device will respond to all inventory requests. Otherwise, if the paging does not contain a re-attempt flag, the device may respond to only a single inventory request.

### [Device Performs a Limited Inventory/Random Access During NW Triggered Discovery]

In one example, a device may perform a limited inventory procedure or random access during a NW triggered discovery procedure. Specifically, a device may receive an indication in paging similar to the re-attempt flag described herein. Upon reception of such indication in paging, a device may perform a limited inventory procedure. In one example, a device may transmit MSG1 only. In another example, a device may transmit a (short) device ID in MSG1. In another example, a device may perform a 2-step random access, rather than a 3-step random access. In another example, a device may transmit a short device ID in MSG3, rather than upper layer data. In another example, a device may transmit a random ID in MSG1, instead of transmitting a deterministic device ID. In another example, a device may transmit a portion of the device ID, rather than the full device ID. In another example, a device may transmit a portion of the upper layer data requested in the inventory rather than the full upper layer data. In another example, a device may perform transmissions with or without power boosting. In another example, a device may transmit at a first (e.g. minimum) power, as compared to a higher power.

For example, a device may respond to the same inventory (e.g., each with the same session ID) triggered by each reader when the paging message contains a re-attempt flag, where such response may comprise performing random access while sending a portion of the application layer data in MSG3. The device may send a random identity in MSG3, or a short AS layer device ID in MSG3, possibly instead of the full application layer data.

[Device Selects a Reader to Respond to]

In one example, upon receiving multiple inventory requests, possibly associated with the same session ID, a device may select a single reader to respond to when. For example, a device may select the reader based on the received signal strength of the reader's transmission. For example, a device may select the reader with the strongest received signal strength, or a reader with a signal strength which is above a threshold.

In another example, a device may select the reader based on the timing of the reader's activity period or synchronization signal relative to the reader's desired activity/charging period. For instance, the device may select the reader which maximizes the device's activity period. For instance, the device may select the reader for which the device's activity period is above a threshold. The device may determine the activity period based on the timing of a synchronization signal from the reader which may be transmitted during/after the paging message. Alternatively, the device may determine the activity period based on the timing of the paging message transmitted by the reader.

### The Order of the Reader's Paging Transmission

In another example, a device may respond to the first reader it receives paging a message from, possibly having the re-attempt flag set. Or the device may respond to the last reader it receives paging message from, possibly having the re-attempt flag set.

### A Receives Number of Remaining Paging Transmissions

In another example, a device may receive, within the paging message, a value indicating the number of further redundant paging message transmissions expected to be received, possibly from the same or different readers. For example, a device may respond to a paging message if there are no additional paging messages to be transmitted, possibly associated with the same session ID. For example, a device may respond to a paging message if the number of additional paging messages to be transmitted is below a threshold. The criteria to determine whether or not to respond to a paging message may be different depending on the number of remaining paging transmissions being above or below a threshold (e.g., the threshold received power which triggers a response may be different for the two cases).

### [Device Indicates the Selected Reader ID in the Response]

In one example, a device may respond to a paging message transmitted by a first reader, but indicate the selected reader (e.g., possibly a different/second reader) in the response to the first reader. For example, a device may select a second reader based on criteria herein (e.g., activity period, receive signal strength). The device may respond to the first reader, while indicating, e.g., in a control element included in a device transmission, the selected (second) reader identity. The reader identity of a reader may be included by the reader in the reader's paging message, or explicitly/implicitly in another reader's transmission. For example, the device may select the reader with best received signal quality, and indicate the selected reader identity in the access associated with the last reader initiated inventory transmission (based on the number of remaining reader inventory procedures) of a given session identity.

### [Device Performs Reader (Re)Selection Only During Inventories Indicated to Allow Such]

In one example, paging message may indicate if a device is allowed to perform reader (re)selection. For instance, a device may respond to the same reader for each successive inventory procedures, possibly associated with different session IDs, unless otherwise allowed by an indication in the paging message. For example, if the paging message contains a flag, a device may select any reader to respond to and/or may indicate the selected reader in the random-access response. If the paging message does not contain a flag, the device may respond to the previously selected reader. A reader may include such a flag based on the occurrence of a mobility event, such as a reselection, a handover, or movement of the reader UE.

### EXEMPLARY EMBODIMENT

An intermediate reader UE may receive, from a network, a request to perform an inventory procedure towards AIOT devices. The request may comprise an associated set of AIOT resources to be used for the inventory procedure. The intermediate reader UE may perform the inventory procedure over the AIOT interface by transmitting an AIOT paging message to trigger a random access transmission from all AIOT devices indicated in the paging message. The intermediate reader UE may measure an AIOT device RSRP or an AIOT device proximity level of each device responding to the paging message. The intermediate reader UE may receive an upper layer AIOT device ID (MSG3) from each device which successfully completes random access. The intermediate reader UE may store the received IDs. The intermediate reader UE may transmit, to the network, an ordered list of AIOT device RSRP or AIOT device proximity level, possibly in the same order as the list of device IDs. The transmission may be sent from the intermediate reader UE to the network in an RRC or NAS message. The intermediate reader UE may receiving an RRC release message, triggering the intermediate reader UE to move to RRC inactive or idle mode. The RRC release message may comprise an indication to the intermediate reader UE to act as a potential reader UE for the AIOT devices. The RRC release message may further comprise a configuration to be used by the UE reader during inactive mode. The configuration may include, for example, a measurement bias (e.g., an RSRP bias) to be used in cells that do not support AIOT operations (i.e., non-AIOT cells) when evaluating cells to camp-on or reselect to. The configuration may further include a time duration during which the measurement bias is valid. The intermediate reader UE may move to inactive or idle mode and apply the configuration received from the network.

While in inactive or idle mode, the intermediate reader UE may perform cell reselection evaluation. For each cell measured, the intermediate reader UE may determine whether or not the cell supports AIOT operations. For cells that do not support AIOT operations, the intermediate reader UE may apply the configured measurement bias to the cell measurements as long as the measurement bias is still valid. The intermediate reader UE may select a cell to camp on based on the biased cell measurements. If the intermediate reader UE is configured to be an active reader and the selected cell does not support AIOT operation, and the measurement bias is valid (e.g., the configured time duration has not expired), the intermediate reader UE may inform the upper layers that the selected cell does not support AIOT.

Once camped on a cell, the intermediate reader UE may trigger an RRC resume procedure. If the UE is configured to be an active reader and the UE selects a cell which does not support AIOT operation while the configured time duration for the validity of the measurement bias has not expired, informing upper layers of such.

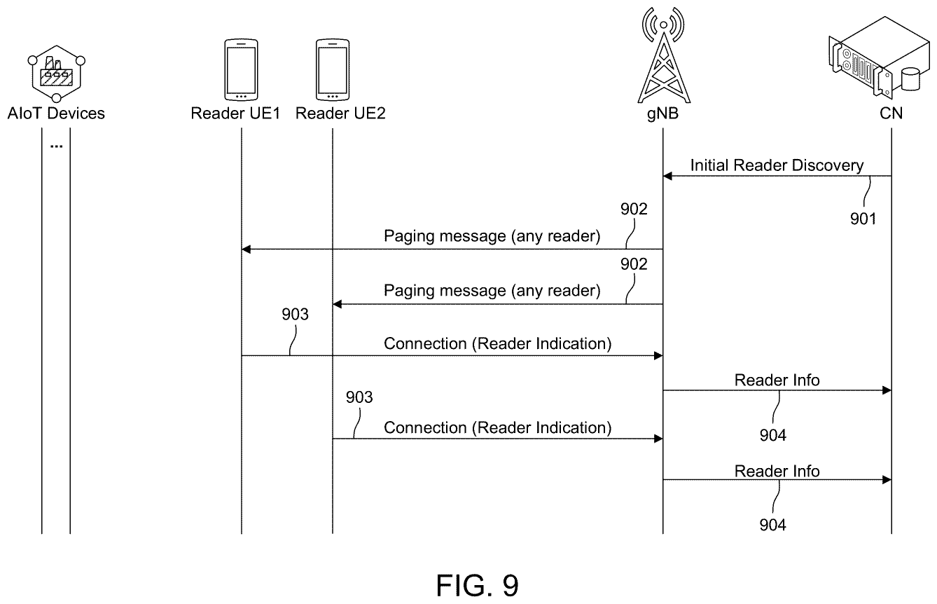

FIG. 9 illustrates an example of a call flow for reader discovery procedure.

FIG. 9 shows the initial steps needed to support a reader UE selection for a group of AIOT devices, which may involve the gathering of information from candidate reader UEs. The core network (CN) may send an initial reader discovery request to the gNB 901. The request may trigger the gNB to send a paging message to all UE readers under its coverage 902. Upon receiving the paging message, the UE readers in the coverage of the gNB, respond to the paging, initiating the establishment of a connection with the network via the gNB 903. In the example in FIG. 9, two reader UEs are shown (reader UE1 and reader UE2), however, there may be many more reader UEs or there may be only one reader UE.

Based on information in the paging message, the reader UEs may provide additional information to the network. For example, the reader UE may include its reader capability, or it may include a cause value indicating it is currently an assigned reader 903. Upon receiving the information, the gNB may forward the information received to the CN 904. The CN may trigger a device inventory operation towards each reader that responds. The inventory may target all devices under coverage of each reader UE. The information collected may then allow the network to select the reader UE which is best suited to each device.

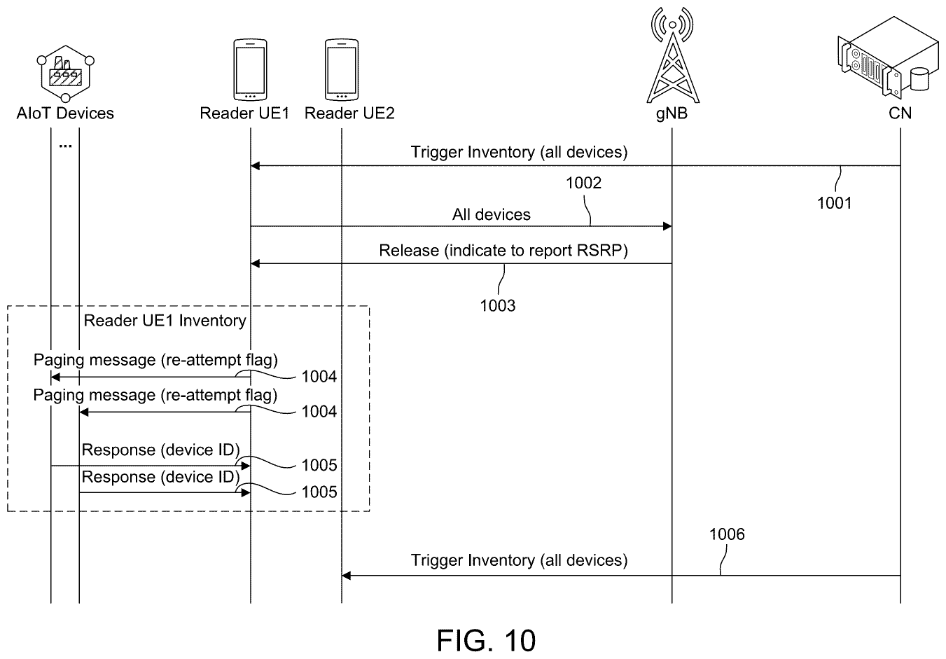

FIG. 10 illustrates an example of a call flow of reader UE1 being triggered to perform an inventory of all AIOT devices under its coverage.

The CN may trigger a device inventory operation towards reader UE1 1001. The trigger is sent from the CN to the reader UE1, and it may go transparently through the gNB.

For the inventory, some information may be relevant to the CN and other information may be relevant to the base station (e.g., gNB). As the message for triggering the inventory may pass transparently through the gNB (e.g., a NAS message), extra steps may be taken to allow gNB to request for relevant information.

Upon receiving the trigger from the CN, reader UE1 may send a message to the gNB 1002 with information about the requested AIOT operation. For example, the information may include information on the requested inventory, such as which devices or group of devices are to be inventoried, the number of devices to be inventoried, or whether the request is for discovery. This may allow the gNB to configure reader UE1 with the AIOT resources to be used for the inventory. This may also allow the gNB to send a request for specific information to be collected during inventory, such as a request for measurements of the inventoried AIOT devices.

After receiving the message from reader UE1 with the information about the requested AIOT operation, the gNB may release the RRC connection of reader UE1, triggering a transition of reader UE1 to RRC inactive mode 1003. In the RRC release message, the gNB may provide configuration to reader UE1, as it was just described above. For example, the gNB may assign AIOT resources for reader UE1 to use during the inventory procedure, e.g., radio resources to be used in communication between each reader UE and all the AIOT devices over the AIOT interface. the gNB may also send a measurement request. For example, the gNB may indicate that reader UE1 is to provide a report of the RSRP measured by reader UE1, for in each AIOT device, when the inventory has been completed.

The inventory procedure may be executed while reader UE1 is in RRC inactive mode. As part of the inventory procedure, reader UE1 may send an AIOT paging message over the AIOT interface to all the AIOT devices to respond 1004. As there may be multiple reader UEs under the same gNB performing inventory (e.g., in this example, there are two reader UEs), reader UE1 may include a flag (e.g., re-attempt flag) in the paging message. The flag may ensure that all AIOT devices respond to the paging, even in a case where the device had just responded to an inventory/paging request from another reader UE.

When responding to the paging message from the reader UE, the AIOT devices may include additional information, such as their device ID and upper layer data corresponding to the inventory request 1005.

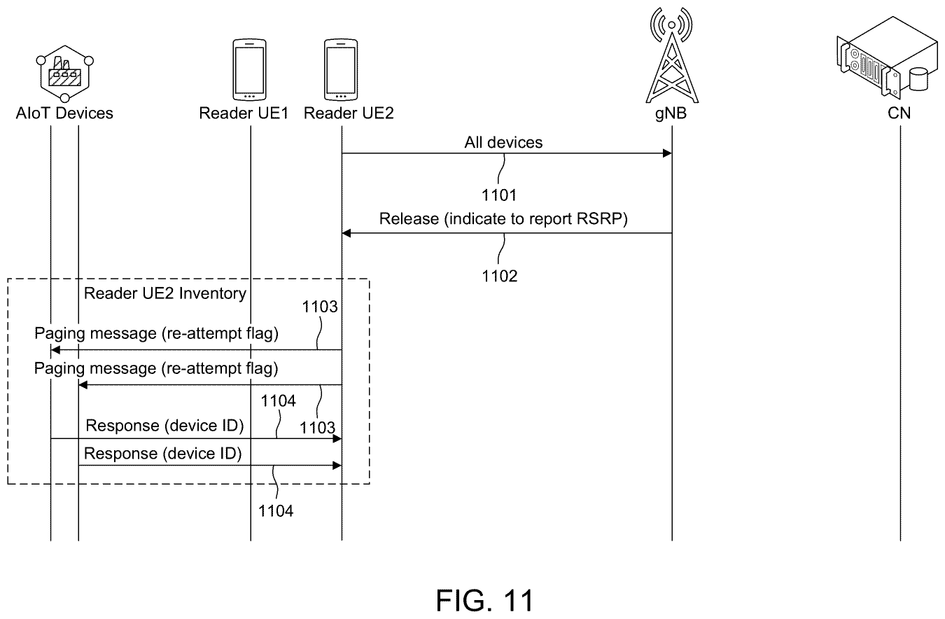

FIG. 11 illustrates an example of a call flow of reader UE2 being triggered to perform an inventory of all AIOT devices under its coverage.

The process for reader UE2 is similar, as shown in FIG. 11. The CN may trigger a device inventory operation towards reader UE2 1101. The trigger is sent from the CN to the reader UE2, and it may go transparently through the gNB. Upon receiving the trigger from the CN, reader UE2 may send a message to the gNB 1102, with information about the requested AIOT operation.

After receiving the message from reader UE2, the gNB may release the RRC connection of reader UE2, triggering a transition of reader UE2 to RRC inactive mode 1103. In the RRC release message, the gNB may provide configuration to reader UE2 (e.g., AIOT resources for reader UE2 to use during the inventory procedure, or a measurement request).

The inventory procedure may be executed while reader UE2 is in RRC inactive mode. As part of the inventory procedure, reader UE2 may send an AIOT paging message over the AIOT interface to all the AIOT devices to respond 1104. Reader UE2 may include a flag (e.g., re-attempt flag) in the paging message.

When responding to the paging message from the reader UE2, the AIOT devices may include additional information, such as their device ID. As this is not the first inventory response in this round, the AIOT devices may not include the upper layer data in the response, and rather may include only include their device ID. The upper layer data may be redundant in case not much time has elapsed since the last inventory or if this part of the same inventory cycle, which may be identified, e.g., via an inventory ID.

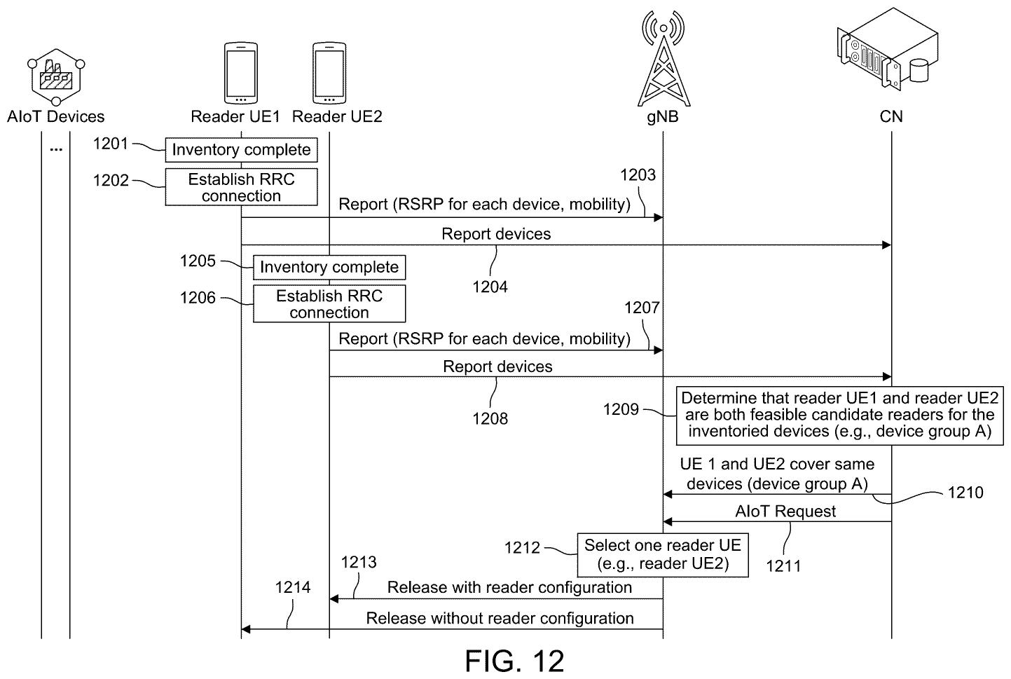

FIG. 12 illustrates an example of a call flow of the network-based reader UE selection.

FIG. 12 shows one example of the reader UE selection being performed by a base station (e.g., gNB). Once the inventory is completed by each reader UE 1201, 1205, each reader UE may establish an RRC connection 1202, 1206 to report results of the inventory. Results may be provided to both gNB 1203, 1207 and CN 1204, 1208. To assist with reader UE selection, which may be done at the gNB, each reader UE may report the measured RSRP valued for each AIOT device 1203, 1207. Each reader UE may also report its mobility-associated information 1203, 1207. Examples of mobility associated information may include an indication that the UE is stationary, nomadic, moving at low speed, or moving at fast speed. It may also include information on UE velocity, including the direction of travel. Furthermore, each reader UE may report, to the CN, information on all inventoried devices, such as AIOT device IDs 1204, 1208.

Even though the request from the CN is transparent to the gNB, the gNB knows the device IDs, which were reported during the reader UE selection. When the CN asks for a specific device, the gNB knows which reader UE the device corresponds to. This part of the process is similar to the CN paging procedure.

So the content of the inventory may be transparent, but the device ID in the request may be visible to the gNB (that's one way). Another way would be for the CN to maintain a mapping of device ID and index in the original inventory, and just refers to the devices by the index (which makes the device ID transparent to the gNB).

Based the reports of the inventoried devices, which are sent from the several reader UEs that were triggered (in this example, two reader UEs, reader UE1 and reader UE2), the CN may determine the accessibility each reader UE has towards the devices of interest. In one example, the CN determines that both reader UE1 and reader UE2 may access the same set of devices of interest, e.g., ‘device group A’ 1209. This means both reader UE1 and reader UE2 are feasible candidate reader UEs to run any AIOT operation associated with any of the AIOT devices in device group A. This information may be determined by the CN and may be provided to the gNB 1210. gNB now has a list with one or more candidate reader UEs able to support an AIOT operation towards any device from group A. The gNB may then select one reader UE from the one or more candidate reader UEs to execute an AIOT procedure.

The gNB may receive, from the CN, an AIOT request for one or more devices from device group A 1211. The gNB may select a reader UE to service that request 1212. Specifically, for future AIOT requests to one or more devices from device group A, the CN may send an AIOT request to the gNB 1211, and the gNB may select the specific reader UE 1212. The reader UE may be selected by the gNB based, for example, on the reported RSRP for each device and/or the information about the reader UE's mobility 1212.

In one example, the gNB may select reader UE2 1212. Following the selection of the reader UE2, the gNB may release the RRC connection of the reader UEs, triggering a transition to RRC inactive. The release message to the reader UE which is selected to be a reader for the specific device group A, in this case the message to reader UE2 1213, may include a reader indication and configuration associated with reader-specific behavior during idle/inactive mode. The configuration may include, e.g. events that may trigger the reader UE to access the network (e.g., send an RRC resume). In one example, the reader UE may be configured to trigger an access with the network to report one or more mobility-associated events. The message may also include a validity time duration, indicating that, after the time duration elapses, the UE is no longer an assigned reader, and a reader selection (or reselection) may be needed for the network to select a new reader for the group (e.g. device group A). The release message to the reader UE which was not selected may be sent without the reader indication or any reader configuration 1214.

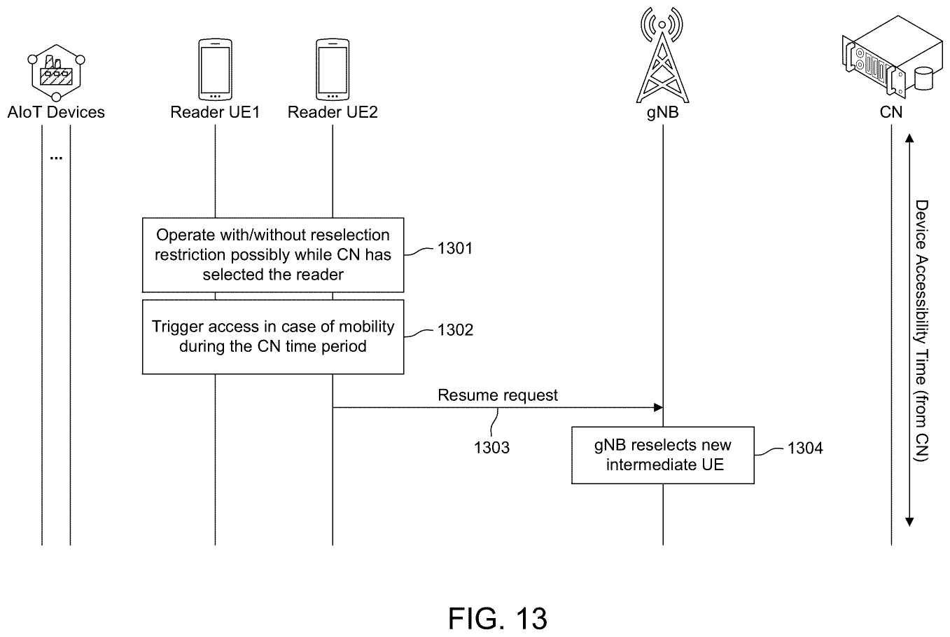

FIG. 13 illustrates an example of a call flow for reader UE reselection.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, WTRU, terminal, base station, RNC, or any host computer.

What is claimed:

1. A method performed by a wireless transmit and receive unit (WTRU) operating in radio resource control (RRC) connected mode in a first ambient internet of things (AIOT) cell, the method comprising:
receiving, from a base station in the first AIOT cell, a command triggering a transition to an inactive mode of operation, wherein the command triggering a transition to an inactive mode of operation comprises a first measurement bias to be applied to a measurement result during evaluation of non-AIOT cells, and a second measurement bias to be applied to a measurement result during evaluation of AIOT cells;
determining a first measurement result from a second cell, and applying, based on a determination that the second cell is a non-AIOT cell, the first measurement bias to the first measurement result;
determining a second measurement result from a third cell, and applying, based on a determination that the third cell is an AIOT cell, the second measurement bias to the second measurement result;
selecting, based on the biased first measurement result and the biased second measurement result, the second cell; and
sending, to an application layer, based on selecting the second cell, an indication that the selected cell does not support AIOT operations.

2. The method of claim 1, wherein the first measurement bias and the second measurement bias are reference signal received power (RSRP) biases to be applied to RSRP measurements.

3. The method of claim 1, wherein the command triggering a transition to an inactive mode of operation further comprises a time duration after which the first measurement bias and the second measurement bias are no longer valid.

4. The method of claim 1, wherein the base station in the first AIOT cell comprises a 5G-NR gNB or an LTE-eNB.

5. The method of claim 1, wherein a base station in a non-AIOT cell does not support AIOT operations.

6. The method of claim 1, wherein the inactive mode of operation comprises one of an RRC idle mode or RRC inactive mode.

7. The method of claim 1, wherein the command triggering a transition to an inactive mode of operation comprises AIOT configuration to be used in the inactive mode of operation.

8. The method of claim 7, wherein the AIOT configuration to be used in the inactive mode of operation comprises a time duration after which the configuration is no longer valid.

9. The method of claim 7, wherein the AIOT configuration to be used in the inactive mode of operation comprises one or more mobility events which trigger the WTRU to establish a communication link with the base station in the first AIOT cell and report the one or more mobility events.

10. The method of claim 9, wherein the one or more mobility events comprise a cell reselection or a measurement of received power from an AIOT device being below a threshold.

11. A wireless transmit and receive unit (WTRU), the WTRU operating in radio resource control (RRC) connected mode in a first ambient internet of things (AIOT) cell, the WTRU comprising:
at least one transceiver and at least one processor, wherein:
the at least one transceiver and at least one processor are configured to receive, from a base station in the first AIOT cell, a command triggering a transition to an inactive mode of operation, wherein the command triggering a transition to an inactive mode of operation comprises a first measurement bias to be applied to a measurement result during evaluation of non-AIOT cells, and a second measurement bias to be applied to a measurement result during evaluation of AIOT cells;
the at least one transceiver and at least one processor are configured to determine a first measurement result from a second cell, and apply, based on a determination that the second cell is a non-AIOT cell, the first measurement bias to the first measurement result;
the at least one transceiver and at least one processor are configured to determine a second measurement result from a third cell, and apply, based on a determination that the third cell is an AIOT cell, the second measurement bias to the second measurement result;
the at least one transceiver and at least one processor are configured to select, based on the biased first measurement result and the biased second measurement result, the second cell; and
the at least one transceiver and at least one processor are configured to send, to an application layer, based on selecting the second cell, an indication that the selected cell does not support AIOT operations.

12. The WTRU of claim 11, wherein the first measurement bias and the second measurement bias are reference signal received power (RSRP) biases to be applied to RSRP measurements.

13. The WTRU of claim 11, wherein the command triggering a transition to an inactive mode of operation further comprises a time duration after which the first measurement bias and the second measurement bias are no longer valid.

14. The WTRU of claim 11, wherein the base station in the first AIOT cell comprises a 5G-NR gNB or an LTE-eNB.

15. The WTRU of claim 11, wherein a base station in a non-AIOT cell does not support AIOT operations.

16. The WTRU of claim 11, wherein the inactive mode of operation comprises one of an RRC idle mode or RRC inactive mode.

17. The WTRU of claim 11, wherein the command triggering a transition to an inactive mode of operation comprises AIOT configuration to be used in the inactive mode of operation.

18. The WTRU of claim 17, wherein the AIOT configuration to be used in the inactive mode of operation comprises a time duration after which the configuration is no longer valid.

19. The WTRU of claim 17, wherein the AIOT configuration to be used in the inactive mode of operation comprises one or more mobility events which trigger the WTRU to establish a communication link with the base station in the first AIOT cell and report the one or more mobility events.

20. The WTRU of claim 19, wherein the one or more mobility events comprise a cell reselection or a measurement of received power from an AIOT device being below a threshold.
